(19) United States
(12) Patent Application Publication
(10) Pub. No.: US 2012/0188843 A1
(43) Pub. Date: Jul. 26, 2012

(54) Axially Operating Stirring Element Manufactured from Sheet Metal

(75) Inventors: Ralf HAHN, Halle (DE); Thomas PENSLER, Langenbogen (DE); Peer SPRINGER, Neuhofen (DE)

(73) Assignee: KSB Aktiengesellschaft, Frankenthal (DE)

(21) Appl. No.: 13/428,217

(22) Filed: Mar. 23, 2012

Related U.S. Application Data
(63) Continuation of application No. PCT/EP2010/063777, filed on Sep. 20, 2010.

(30) Foreign Application Priority Data
Sep. 24, 2009 (DE) 10 2009 042 843.7
Sep. 4, 2010 (DE) 10 2010 044 423.5

(51) Int. Cl. F01D 5/14; B23P 17/00; B01F 5/12

(52) U.S. Cl. 366/270; 416/235; 29/889.3

(57) ABSTRACT

An axially operating stirring element, preferably a propeller manufactured from sheet metal, having propeller blades arranged radially around an axis (A) and in which at least one propeller blade has a sharpened edge on the discharge or trailing edge side.

### CROSS REFERENCE TO RELATED APPLICATIONS

This application is a continuation of international patent application no. PCT/EP2010/063777, filed Sep. 20, 2010, designating the United States of America and published in German on Mar. 31, 2011 as WO 2011/036113 A2, the entire disclosure of which is incorporated herein by reference. Priority is claimed based on Federal Republic of Germany patent application nos. DE 10 2009 042 843.7, filed Sep. 24, 2009 and DE 10 2010 044 423.5, filed Sep. 4, 2010, the entire disclosures of each of which are likewise incorporated herein by reference.

### BACKGROUND OF THE INVENTION

The present invention concerns an axially operating stirring element, preferably a propeller, manufactured from sheet metal with blades arranged radially about an axis, and the use of such a stirring element in an agitation mechanism for stirring and/or mixing, and a method for production of such a stirring element.

Axially operating propellers are known in numerous embodiments from the prior art. Examples are propellers in the agitation mechanism of models Amamix 300 or Amamix 400 by KSB Aktiengesellschaft. These models are used amongst others as horizontal immersion motor agitators for mixing, homogenizing and thickening community or industrial effluent and slurry. The propellers used are particularly suitable for this since they are produced from sheet metal materials which are resistant to the fluid transported, in particular resistant to corrosion.

Propellers which have a constant or almost constant metal or blade thickness, on rotation in the sometimes viscous media to be stirred, incur higher power losses on the trailing edge than in propellers with profiled blades, with the latter however being substantially more complicated to produce. Thus more energy must be used to rotate the propeller through the viscous medium with a constant high rotation speed.

It is known from the prior art to chamfer and sharpen the blades on their leading or inlet side (front) to reduce face resistance losses.

### SUMMARY OF THE INVENTION

It is an object of the present invention is to further reduce the rotation resistance of an axially operating stirring element such as a propeller.

Another object is to provide an axially operating stirring element which achieves a perceptible saving in the energy required for the agitation process.

A further object of the invention is therefore, on use of a stirring element according to the invention, to achieve a better stirring result with the same energy usage, a constant stirring result with lower energy usage or an improved stirring result with lower energy usage.

These and other objects are achieved by the use of an axially operating stirring element as described and claimed hereinafter.

In accordance with the invention, an axially operating stirring element, preferably a propeller, with blades arranged radially about an axis is provided with at least one blade which has an edge sharpened on the trailing or outlet side.

As used herein, the term “axial” stirring elements refers to stirring elements on which the blades are arranged radially and mostly obliquely about a rotary axis. In operation of such an axial stirring element, the primary flow of the stirred medium is always aligned axially.

The inlet side or front is understood to be that edge of the blade which in operation of the stirring element leads in the proposed direction of rotation.

The outlet side or rear is understood to be that edge of the blade which in operation of the stirring element trails in the proposed direction of rotation.

Preferred embodiments of the invention are described hereinafter.

In a first preferred embodiment of the invention, one or more blades are also sharpened on the inlet side. The thrust/power ratio can be improved with optimum grinding. In a further embodiment with corresponding sharpening on the front and rear side, the improvements resulting from sharpening just on the front or rear side are clearly exceeded.

In a further embodiment, a stirring element according to the invention has at least one blade with said properties. Preferably several, half or all blades of the stirring element according to the invention are sharpened on the inlet and/or outlet side.

It has been found that on rotation of such a stirring element through a viscous medium, turbulence and eddying occurs not only on the inlet side but also on the outlet side (rear) of the blades due to the lack of streamlining, which provokes rotation resistance and hence power losses. The eddying on the outlet edge constitutes a loss, the magnitude of which has previously not been taken into account in the prior art. Sharpening, i.e. chamfering, achieves a reduction in power losses and hence an improved thrust/power ratio on rotation above all of otherwise simply constructed axial sheet metal propellers.

In a further embodiment of the invention in which one or more blades are sharpened on the front and/or rear, the sharpening at the inlet and/or outlet side individually comprises a pitch angle of between 5° to around 30°, preferably between around 10° to around 15°. If several blades sharpened on the outlet side are provided, this pitch angle can have a constant angle over all blades. The same applies if several blades sharpened on the inlet side are present.

Furthermore, in one embodiment, it can be provided that with ground front and/or rear sides, the grinding is applied to the intake side of the blades. The top of the blade is understood to be that side along the rotary axis from which the stirred medium flows through the stirring element on rotation of the propeller in the proposed direction of rotation, i.e. the upstream side of the blades. Such grinding can have a further positive effect on the possibility of automation and the cost of construction.

In another embodiment, it is not the entire edge which is sharpened but only one region. This can preferably be the outer region i.e. that further removed from the rotary axis, since here, at the same rotation speed, the absolute speed of the edges through the medium is higher than in the inner region. Thus in one embodiment, the blades are treated only in the outer two-thirds or only the outer half. These values should be regarded by the person skilled in the art as approximate values and depend largely on the size and shape of the propeller and the area of application and the operating rotation speed.

Experiments have further shown that above all with smaller propellers characterized by relatively short blade lengths, the rotation speed of which where applicable can be relatively high, i.e. in the region of above 600 rpm, above 800 rpm, above 1000 rpm and even above 2000 rpm, losses can occur on the outlet side which are no longer negligible.

Therefore, such a stirring element in one embodiment has a total diameter of between around 20 cm and around 1 m, preferably between around 30 cm and around 60 cm and particularly preferably between around 30 cm and around 40 cm. In another embodiment, the total diameter is between around 40 cm and 80 cm. Stirring element diameters greater than 1 m are however also suitable for use in corresponding agitation mechanisms and lead to a perceptible gain in thrust/power ratio.

In one preferred embodiment of the present invention, one or more blades are made of sheet metal. Such a construction of sheet metal in practice has the advantage of comparatively cheap production and high stability. The term “sheet metal” means a flat or almost flat plate of metal. Many metals and above all alloys are suitable as raw materials for the present application, in one embodiment however sheet steel and aluminum sheet resistant to the fluids to be transported are particularly suitable.

In a further embodiment of the invention, one or more blades have a constant thickness outside the sharpened places. This is also economically advantageous in production, establishes a moderate weight of the propeller agitator and has the advantage of low rotation resistance. Sheet metal normally has a constant thickness over its surface area. In a further embodiment of the invention, the blades or material forming the blades, preferably sheet metal, is between 3 and 15 mm, preferably between 3 and 8 mm, thick. These values naturally also vary depending on application and stirring element diameter.

In a preferred embodiment, one or more blades are curved. This construction is advantageous in a propeller agitator in order to create a main axis which is as axial as possible in the flow direction of the stirred medium. Preferably the curvature on each side of the blade has a uniform prefix or is O. In another embodiment, the curvature is designed such that at the point of fixing to the shaft, in an alignment angled in relation to the rotation direction and at the outer ends, the blades have a position along the rotation direction.

It can therefore be advantageous constructionally, if in a preferred embodiment one metal sheet is used for construction of a propeller, that this sheet is bent into the form of a blade and welded to a propeller hub.

In one preferred embodiment, one or more blades are sickle-shaped. This sickle-shaped form can result both from the shape of the uncurved material, preferably the metal sheet, or in a top view of the blades along the rotary axis. In a preferred embodiment, the blades do not narrow on the outside but are rounded or cut obliquely or tangentially. Such a design leads to a high stability of the blades up to their end regions and lower turbulence formation.

In a further preferred embodiment, at least two blades are designed in size, spacing and/or shape such that, in a top view in the direction of the rotary axis, individual blades are superimposed. Preferably all blades have the same mutual spacing, at least however have a regular spacing pattern. The preferred number of blades of a propeller according to the invention is usually between 2 and around 10 blades, preferably between 2 and 5 blades and particularly preferably precisely 3 blades. Over their length (approximately D/2), determined more precisely at the top by the diameter, the blades have a width of between 5 cm and 30 cm, preferably between around 10 cm and 25 cm. This size can relate both to the width in relation to the metal sheet before bending and to the width of the propeller in a top view from an axial direction.

Such propellers can be introduced centrally or eccentrically into a medium to be mixed or stirred. Several such propellers are also conceivable within one medium. The propeller can be introduced into the target region along an axis vertically from above or from below or also laterally, obliquely and/or at an angle.

A further feature of the invention is the use of the stirring element just described. In a preferred use, such a stirring element is used in an agitation mechanism for stirring and/or mixing. Use in a mixer or an immersion motor agitator is preferred, particularly preferably for mixing, homogenizing and thickening preferably community and/or industrial effluent or slurry. In one embodiment, the propeller undergoes between around 100 and around 1500 revolutions per minute, preferably between around 500 and around 1000 revolutions per minute. An example maximum drive power for industrial use is around 5 kW. Preferably such a propeller is driven with an electric motor.

Thus the invention also comprises agitation mechanisms which are suitable for said application and comprise a stirring element according to the invention.

Furthermore, the invention comprises a method for production of an axial propeller with the steps of producing at least one sheet metal piece in a form suitable for a blade by punching, cutting, weld-cutting and/or another suitable method, bending the at least one sheet metal piece, sharpening the at least one sheet metal piece on at least its planned outlet side, and welding the at least one sheet metal piece to a propeller hub.

The method is intended to be used to produce a stirring element according to the invention in accordance with any one of the proposed embodiments. The specifications proposed above in relation to the individual embodiments for the various possible compositions of stirring elements according to the invention therefore also apply to the process steps. The order listed in the preceding paragraph and in claim 15 should not be understood restrictively. In particular, the steps of forming, particularly in the form of pressing or compression, sharpening and welding of a sheet metal piece can be interchanged as required.

### BRIEF DESCRIPTION OF THE DRAWINGS

Features, details and benefits of the invention are explained hereinafter with reference to illustrative embodiments shown in the accompanying drawings, in which:

FIG. 1 is a perspective view of a stirring element according to the invention;

FIG. 1a is a perspective view of a stirring element from the prior art;

FIG. 2 is an illustration of a propeller according to the invention;

FIG. 2a shows a blade of a propeller according to the invention;

FIG. 3 shows a cross section through a blade according to the invention; and

FIG. 3a shows cross section through a blade from the prior art.

### DETAILED DESCRIPTION OF ILLUSTRATIVE EMBODIMENTS

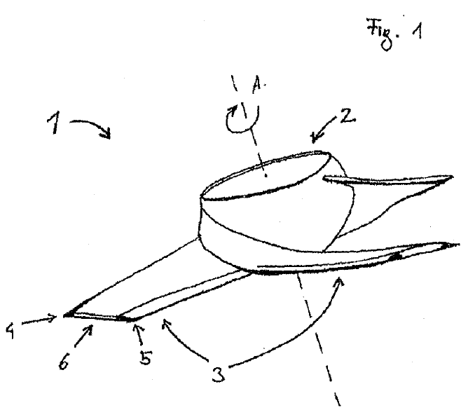

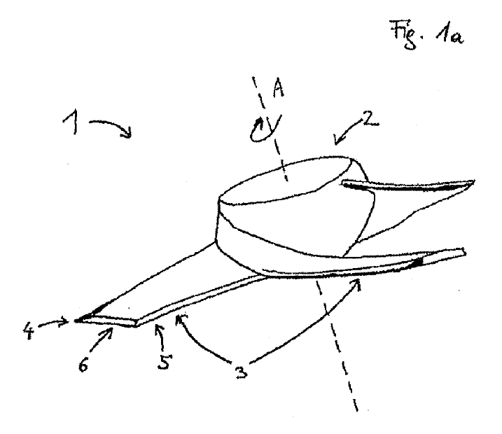

FIG. 1 shows a propeller agitation mechanism with a propeller according to the invention. The propeller 1 is attached along axis A to a propeller hub 2. The blades 3 are curved. They have an inlet side 4 and an outlet side 5 and are trimmed at their outer ends 6. Both the edge on the inlet side 4 and the edge on the outlet side 5 are sharpened.

This is in contrast to FIG. 1 a in which the same propeller is shown without sharpening on the outlet edge. Such a propeller corresponds to the prior art.

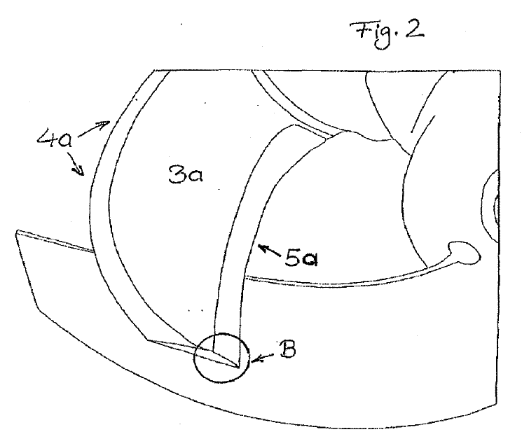

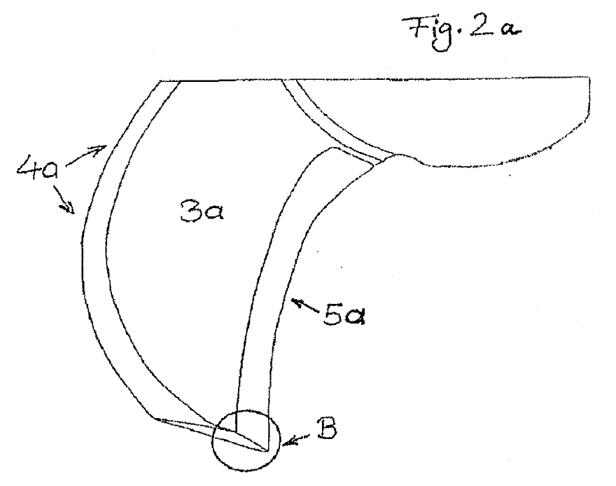

FIG. 2 is a depiction of a part of a propeller according to the invention. This prototype was produced on the basis of the Amamix 300 model by KSB Aktiengesellschaft by milling the outlet side. Blade 3a is particularly clearly shown. Blade 3a in this depiction is placed on a blade of a second propeller according to FIG. 1 arranged conversely. The propeller hub 2 and propeller hub 2.1 of the propeller according to the prior art lie against each other.

FIG. 2a is a depiction of a part of a propeller according to the invention in the form of a single blade 3a. The convex curved part 4a of the sickle- shaped blade 3a constitutes the inlet side and the concave curved part 5a the outlet side. It is clearly evident that the blade has been chamfered at the outlet side (marked B). The sharpening on both sides substantially reduces the stirring resistance and achieves an improved thrust/power ratio.

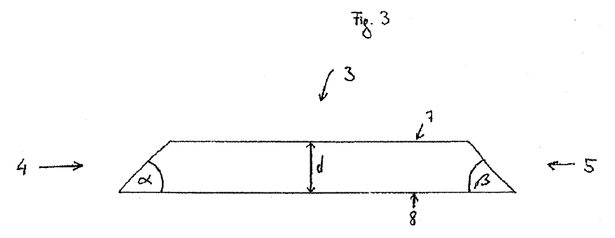

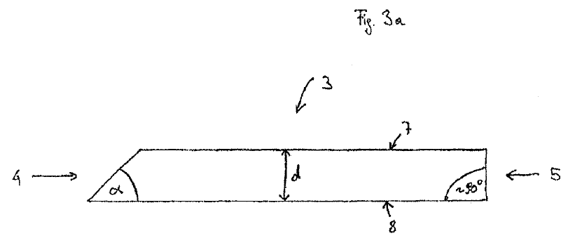

FIG. 3 shows the cross section of a blade from a propeller according to the invention. For the sake of simplicity, blade 3 is shown straight in cross section i.e. not curved. The inlet side 4 and outlet side 5 are sharpened to angles α, and β. These angles can lie individually in the range given in the general part of the application for the cutting angle. The top side 7 and bottom side 8 are parallel to each other and the blade 3 has a uniform thickness d over its entire width. In this embodiment example, it is also assumed that the blade has a uniform thickness d over its entire surface area. The thickness is shown as value d in FIG. 3 and preferably lies in the range given in the general part of the description.

In contrast, FIG. 3a shows a cross section of a blade from the prior art. Angle here is approximately 90°. The edge on the outlet side is not sharpened.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

1. An axially operating stirring element wherein said stirring element is manufactured from sheet metal and comprises blades arranged radially about an axis, and at least one blade has an edge sharpened on the outlet side.

2. The axially operating stirring element as claimed in claim 1, wherein said stirring element is a propeller.

3. The axially operating stirring element as claimed in claim 1, wherein said at least one blade also has an edge sharpened on the inlet side.

4. The axially operating stirring element as claimed in claim 1, wherein a plurality of said blades have edges sharpened on the outlet side.

5. The axially operating stirring element as claimed in claim 1, wherein all of said blades have edges sharpened on the outlet side.

6. The axially operating stirring element as claimed in claim 1, wherein all of said blades have edges sharpened on the inlet and outlet sides.

7. The axially operating stirring element as claimed in claim 1, wherein the sharpened edge has a pitch angle of between 5° and 30°.

8. The axially operating stirring element as claimed in claim 7, wherein the sharpened edge has a pitch angle between 10° and 15°.

9. The axially operating stirring element as claimed in claim 6, wherein the sharpened edges have a constant pitch angle over all propeller blades.

10. The axially operating stirring element as claimed in claim 1, wherein the sharpened edge is applied by grinding on the intake side of the at least one blade.

11. The axially operating stirring element as claimed in claim 1, wherein only part of the edges are sharpened.

12. The axially operating stirring element as claimed in claim 11, wherein the outer half of the edge is sharpened.

13. The axially operating stirring element as claimed in claim 12, wherein the outer two-thirds of the edge is sharpened.

14. The axially operating stirring element as claimed in claim 1, wherein said at least one blade has a constant thickness outside the sharpened places.

15. The axially operating stirring element as claimed in claim 1, wherein the at least one blade is made of sheet metal bent into the form of the blade and is welded to a propeller hub.

16. The axially operating stirring element as claimed in claim 1, said at least one blade is formed sickle-shaped and is rounded or cut obliquely or tangentially at its outer end.

17. The axially operating stirring element as claimed in claim 1, wherein, in a top view in the direction of the axis, at least two individual blades are superimposed.

18. An agitation mechanism for stirring or mixing, comprising a mixer or immersion motor agitator with a stirring element as claimed in claim 1.

19. A method for producing an axial stirring element comprising the following steps in any order:
a) producing at least one sheet metal piece in a form suitable for a blade;
b) forming, pressing or compressing the at least one sheet metal piece;
c) sharpening the at least one sheet metal piece on at least its planned outlet side; and
d) welding the at least one sheet metal piece to a propeller hub.

20. A method as claimed in claim 19, wherein the at least one sheet metal piece is produced in a form suitable for a blade by punching, cutting or weld-cutting.
